(19) United States
(12) Patent Application Publication
(10) Pub. No.: US 2003/0196061 A1
(43) Pub. Date: Oct. 16, 2003

(54) System and method for secure execution of multiple applications using a single GC heap

(76) Inventors: Hideya Kawahara, Mountain View, CA (US); Grzegorz J. Czajkowski, Mountain View, CA (US)

Correspondence Address: B. Noel Kivlin, Conley, Rose, & Tayon, P.C., P.O. Box 398, Austin, TX, 78767, US

(21) Appl. No.: 10/123,702

(22) Filed: Apr. 16, 2002

(51) Int. Cl. G06F 12/00

(52) U.S. Cl. 711/170; 711/159; 711/147

(57) ABSTRACT

A system and method for secure execution of multiple applications using a single GC heap are provided. A root set is maintained for each of the applications. Each root set includes one or more pointers objects stored in the heap. After a garbage collection operation is performed, the root sets may be used to measure resources consumption by each of the applications. The root sets may be used to measure heap consumption by associating each data structure in the memory with a particular application based on reachability from the application's root set. The root sets may be used to measure CPU time consumption during the GC by dividing the total time consumed by the GC by the total amount of the memory or number of objects used by the application. An object finalizer may be executed in a finalizer thread for each application to help limit GC-related misbehavior to GC of the objects of the misbehaving application itself. In one embodiment, static fields of some classes may be shared among applications. To prevent the compromising of the GC security, static files may be replicated per application.

### BACKGROUND OF THE INVENTION

1. Field of the Invention

The present invention relates generally to computer software. More particularly, the present invention relates to the secure execution of applications in a multi-processing environment.

2. Description of the Relevant Art

The growing popularity of the platform-independent programming language Java™ has brought about an increased need for executing multiple Java™ applications co-located on the same computer. These Java™ applications often expect that the environment in which they are executing will perform automatic garbage collection for efficient memory management. Garbage collection (GC) is a mechanism for managing an area of memory (usually called a heap) in a computer system. The memory heap may be shared by multiple applications which may be executing concurrently. Typically, GC is periodically performed by searching all or part of the memory heap to determine which part of that area (e.g., which data structures or objects) are being used. GC may then “clean up” the portion of the heap which is not being used by preparing it for later use (e.g., freeing it) by the applications. GC is therefore useful for reclaiming unused memory in a manner that is generally automatic and transparent to applications.

Nevertheless, current approaches towards GC have their drawbacks. For example, the use of a single GC heap among multiple applications is known to have at least three problems. These three areas of concern are discussed as follows.

The first problem is that GC heap consumption per application cannot be measured efficiently. Thus, GC heap consumption per application cannot be limited efficiently. Limiting GC heap consumption may be an important step in providing a secure application environment. For example, faulty or malicious applications should be prevented from consuming too much of the heap in a secure environment. Because a single heap may be shared by multiple applications, determining how much of the heap is used by each application poses problems. It is usually possible to determine GC space used by each object at object creation and to accumulate per-application heap consumption in this manner. However, after GC takes place, this count is no longer correct. Because of the shared nature of the heap, it is difficult to know how much of the heap is used by each application after GC. One approach might include allocating a flag per object to identify to which application that object belongs. However, this approach requires extra memory and may therefore be unacceptably inefficient in environments like embedded systems where memory is at a premium.

The second problem is that the aforementioned approach may be vulnerable to denial-of-service attacks. For example, a faulty or malicious application may allocate and discard objects at a high rate. This behavior may cause frequent GCs and may therefore consume a significant amount of system resources such as CPU time. Because a single heap is shared by multiple applications, it is not clear which application is responsible for CPU time consumed by a GC. If time consumed by GCs is ignored and not charged to individual applications, a malicious application may intentionally cause GCs by creating and discarding a great number of objects. This may hinder normal execution of other applications.

The third problem is vulnerability to a finalizer attack. A malicious application may create and discard an object which has a finalizer that takes a long time to finish or that never terminates. In some environments, such as certain Java™ Virtual Machines (JVMs), finalizers for objects are executed just prior to discarding those objects during GC. Finalizers are typically executed by a single dedicated thread. Therefore, if one finalizer takes a long time to execute or never terminates, finalizers for other objects may be prevented from executing. These other objects may not be properly discarded from the GC heap, and unnecessary memory consumption may result.

In general, providing one GC heap per application may provide a solution for these problems. However, this solution is memory-hungry. Multiple heaps bind a fixed amount of memory for each application, and it often costly to grow or shrink such heaps. The need for such growth or shrinkage may arise when an application terminates or when a new application begins executing. This approach may therefore tend to consume a large amount of memory, especially if the environment (e.g., the target device or computer system) does not include a Memory Management Unit (MMU). Consequently, this approach is undesirable for a small-footprint or memory-constrained environment such as a consumer or embedded system.

Therefore, improved systems and methods for secure and efficient execution of multiple applications using a single GC heap are desired.

### SUMMARY OF THE INVENTION

The problems outlined above are in large part solved by various embodiments of a system and method for secure execution of multiple applications using a single GC heap as disclosed herein. The applications may include applets, servlets, operating system services, components, JavaBeans™, or other suitable executable units or programs. “Application” and “program” are herein used synonymously. In one embodiment, the applications are executable in a platform-independent programming environment such as the Java™ environment. In one embodiment, the applications are executable on a single instance of a virtual machine, such as a Java™ Virtual Machine, which is implemented in accordance with a platform-independent virtual machine specification, such as the Java™ Virtual Machine Specification.

The method for sharing a single GC heap among a plurality of applications may include maintaining a root set for each of the applications during their execution. Each root set may include one or more pointers or other references to data structures (e.g., objects) stored in the memory heap. After a garbage collection operation is performed, the root sets may be used to measure one or more resources consumed by each of the applications.

The root sets may be used to measure heap consumption by associating each data structure in the memory with a particular application based on reachability from the application's root set. A total amount of the heap used by the application may then be determined by summing the memory consumption of each of the data structures associated with the application.

The root sets may be used to measure CPU time consumption during the GC by determining a total CPU time consumed by the GC, determining a total amount of the memory used by each of the applications (as discussed above), and determining the CPU time consumption for each of the applications by dividing the total time consumed by the GC by the total amount of the memory used by the application. Alternately, the total number of data structures per application may be used instead of the total heap consumption per application.

In one embodiment, the applications may include a plurality of threads. In this case, an application identifier may be stored with each of the threads belonging to a particular application, and the application identifier may refer to the particular application. In one embodiment, each of the applications may include a finalizer thread. An object finalizer may be executed in the finalizer thread for each application. In this manner, GC-related misbehavior may be limited to GC of the objects of the misbehaving application itself.

In one embodiment, static fields of some classes may be shared among applications. To prevent the compromising of the GC security measures summarized above, static files may be replicated per application.

### BRIEF DESCRIPTION OF THE DRAWINGS

Other objects and advantages of the invention will become apparent upon reading the following detailed description and upon reference to the accompanying drawings in which:

FIG. 1 is an illustration of a typical computer system architecture which is suitable for implementing various embodiments.

FIG. 2 is an illustration of a Java™ Platform architecture which is suitable for implementing various embodiments.

FIG. 3 is a diagram illustrating secure execution of multiple applications using a single GC heap according to one embodiment.

FIG. 4 is a flowchart illustrating a method of secure execution of multiple applications using a single GC heap according to one embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

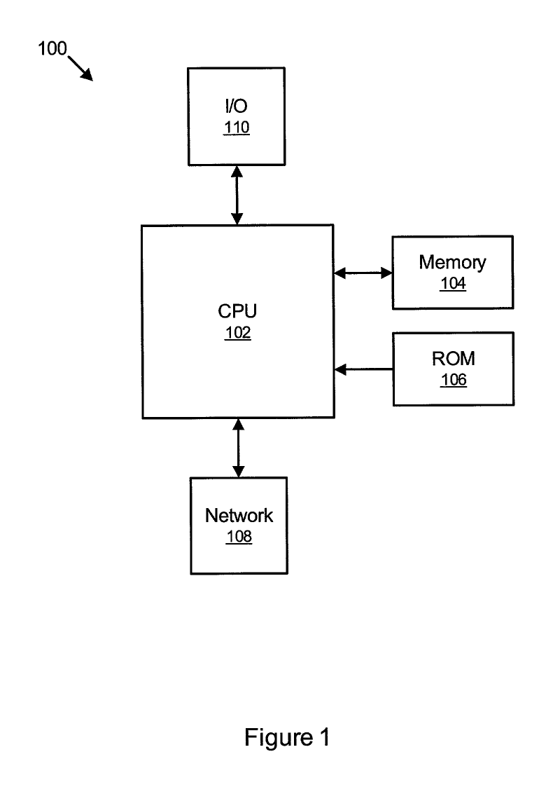

FIG. 1: A Typical Computer System

Turning now to the drawings, FIG. 1 is an illustration of a typical, general-purpose computer system 100 which is suitable for implementing the system and method for secure execution of multiple applications using a single GC heap as disclosed herein. The computer system 100 may include at least one central processing unit (CPU) or processor 102. The CPU 102 is coupled to a memory 104 and a read-only memory (ROM) 106. The memory 104 is representative of various types of possible memory media: for example, hard disk storage, floppy disk storage, removable disk storage, or random access memory (RAM). The terms “memory” and “memory medium” may include an installation medium, e.g., a CD-ROM or floppy disk, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution.

As shown in FIG. 1, typically the memory 104 permits two-way access: it is readable and writable. The ROM 106, on the other hand, is readable but not writable. The memory 104 and/or ROM 106 may store instructions and/or data which implement all or part of the systems and methods described in detail herein, and the memory 104 and/or ROM 106 may be utilized to install the instructions and/or data. In various embodiments, the computer system 100 may take various forms, including a personal computer system, desktop computer, laptop computer, palmtop computer, mainframe computer system, workstation, network appliance, network computer, Internet appliance, personal digital assistant (PDA), embedded device, smart phone, television system, or other suitable device. In general, the term “computer system” can be broadly defined to encompass any device having a processor which executes instructions from a memory medium.

The CPU 102 may be coupled to a network 108. The network 108 is representative of various types of possible networks: for example, a local area network (LAN), wide area network (WAN), or the Internet. The systems and methods for secure execution of multiple applications as disclosed herein may therefore be implemented on a plurality of heterogeneous or homogeneous networked computer systems 100 through one or more networks 108. The CPU 102 may acquire instructions and/or data for implementing the systems and methods for a secure execution of multiple applications using a single GC heap as disclosed herein over the network 108.

Through an input/output bus 110, the CPU 102 may also coupled to one or more input/output devices that may include, but are not limited to, video monitors or other displays, track balls, mice, keyboards, microphones, touch-sensitive displays, magnetic or paper tape readers, tablets, styluses, voice recognizers, handwriting recognizers, printers, plotters, scanners, and any other devices for input and/or output. The CPU 102 may acquire instructions and/or data for implementing the systems and methods for secure execution of multiple applications as disclosed herein through the input/output bus 110.

The computer system 100 is operable to execute one or more computer programs. The computer programs may comprise operating system or other system software, application software, utility software, Java™ applets, and/or any other sequence of instructions. Typically, an operating system performs basic tasks such as recognizing input from the keyboard, sending output to the display screen, keeping track of files and directories on the disk, and controlling peripheral devices such as disk drives and printers. Application software runs on top of the operating system and provides additional functionality. Because applications take advantage of services offered by operating systems, and because operating systems differ in the services they offer and in the way they offer the services, an application must usually be designed to run on a particular operating system. The computer programs are stored in a memory medium or storage medium such as the memory 104 and/or ROM 106, or they may be provided to the CPU 102 through the network 108 or I/O bus 110.

In one embodiment, the computer programs executable by the computer system 100 may be implemented in the Java™ Language. The Java™ Language is described in The Java Language Specification by Gosling, Joy, and Steele (Addison-Wesley, ISBN 0-201-63451-1), which is incorporated herein by reference. A general discussion of the Java™ Language follows. The Java™ Language is an object-oriented programming language. In an object-oriented programming language, data and related methods can be grouped together or encapsulated to form an entity known as an object. All objects in an object-oriented programming system belong to a class, which can be thought of as a category of like objects which describes the characteristics of those objects. Each object is created as an instance of the class by a program. The objects may therefore be said to have been instantiated from the class. The class sets out variables and methods for objects which belong to that class. The definition of the class does not itself create any objects. The class may define initial values for its variables, and it normally defines the methods associated with the class (i.e., includes the program code which is executed when a method is invoked.) The class may thereby provide all of the program code which will be used by objects in the class, hence maximizing re-use of code which is shared by objects in the class.

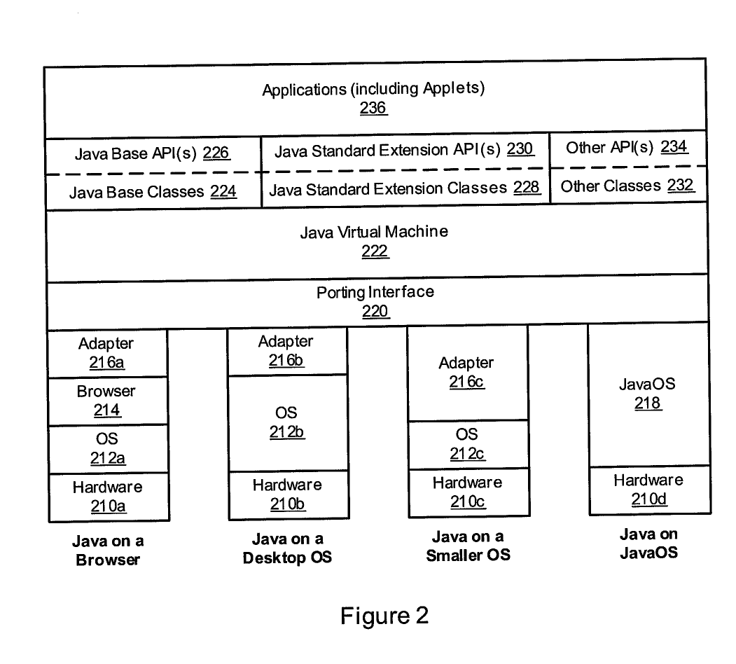

FIG. 2: The Java™ Platform

The Java™ Platform which utilizes the object-oriented Java™ Language is a software platform for delivering and running the same applications on a plurality of different operating systems and hardware platforms. As will be described in further detail below, the Java™ Platform includes system-dependent portions and system-independent portions, and therefore the Java™ Platform may be thought of as having multiple embodiments. The Java™ Platform sits on top of these other platforms, in a layer of software above the operating system and above the hardware. FIG. 2 is an illustration of the Java™ Platform and the relationships between the elements thereof in one embodiment. The Java™ Platform has two basic parts: the Java™ Virtual Machine 222, and the Java™ Application Programming Interface (Java™ API). The Java™ API may be thought of as comprising multiple application programming interfaces (APIs). While each underlying platform has its own implementation of the Java™ Virtual Machine 222, there is only one Virtual Machine specification. The Java™ Virtual Machine specification is described in The Java Virtual Machine Specification by Lindholm and Yellin (Addison-Wesley, ISBN 0-201-63452-X), which is incorporated herein by reference. By allowing the Java™ applications 236 to execute on the same Virtual Machine 222 across many different underlying computing platforms, the Java™ Platform can provide a standard, uniform programming interface which allows Java™ applications 236 to run on any hardware on which the Java™ Platform has been implemented. The Java™ Platform is therefore designed to provide a “write once, run anywhere” capability.

Developers may use the Java™ Language and Java™ APIs to write source code for Java™-powered applications 236. A developer compiles the source code only once to the Java™ Platform, rather than to the machine language of an underlying system. Java™ programs compile to bytecodes which are machine instructions for the Java™ Virtual Machine 222. A program written in the Java™ Language compiles to a bytecode file which can run wherever the Java™ Platform is present, on any underlying operating system and on any hardware. In other words, the same Java™ application can run on any computing platform that is running the Java™ Platform. Essentially, therefore, Java™ applications 236 are expressed in one form of machine language and are translated by software in the Java™ Platform to another form of machine language which is executable on a particular underlying computer system.

The Java™ Virtual Machine 222 is implemented in accordance with a specification for a “soft” computer which can be implemented in software or hardware. As used herein, a “virtual machine” is generally a self-contained operating environment that behaves as if it were a separate computer. As shown in FIG. 2, in one embodiment, the Java™ Virtual Machine 222 is implemented in a software layer. Various implementations of the Java™ Virtual Machine 222 can run on a variety of different computing platforms: for example, on a browser 214 sitting on top of an operating system (OS) 212a on top of hardware 210a; on a desktop operating system 212b on top of hardware 210b; on a smaller operating system 212c on top of hardware 210c; or on the JavaOS operating system 218 on top of hardware 210d. Computer hardware 210a, 210b, 210c, and 210d may comprise different hardware platforms. JavaOS 218 is an operating system that is optimized to run on a variety of computing and consumer platforms. The JavaOS 218 operating environment provides a runtime specifically tuned to run applications written in the Java™ Language directly on computer hardware without requiring another operating system.

The Java™ API or APIs form a standard interface to Java™ applications 236, regardless of the underlying operating system or hardware. The Java™ API or APIs specify a set of programming interfaces between Java™ applications 236 and the Java™ Virtual Machine 222. The Java™ Base API 226 provides the basic language, utility, I/O, network, GUI, and applet services. The Java™ Base API 226 is typically present anywhere the Java™ Platform is present. The Java™ Base Classes 224 are the implementation of the Java™ Base API 226. The Java™ Standard Extension API 230 provides additional capabilities beyond the Java™ Base API 226. The Java™ Standard Extension Classes 228 are the implementation of the Java™ Standard Extension API 230. Other APIs in addition to the Java™ Base API 226 and Java™ Standard Extension API 230 can be provided by the application or underlying operating system. A particular Java™ environment may include additional APIs 234 and the classes 232 which implement them. Each API is organized by groups or sets. Each of the API sets can be implemented as one or more packages or namespaces. Each package groups together a set of classes and interfaces that define a set of related data, constructors, and methods, as is well known in the art of object-oriented programming.

The porting interface 220 lies below the Java™ Virtual Machine 222 and on top of the different operating systems 212b, 212c, and 218 and browser 214. The porting interface 220 is platform-independent. However, the associated adapters 216a, 216b, and 216c are platform-dependent. The porting interface 220 and adapters 216a, 216b, and 216c enable the Java™ Virtual Machine 222 to be easily ported to new computing platforms without being completely rewritten. The Java™ Virtual Machine 222, the porting interface 220, the adapters 216a, 216b, and 216c, the JavaOS 218, and other similar pieces of software on top of the operating systems 212a, 212b, and 212c may, individually or in combination, act as means for translating the machine language of Java™ applications 236, APIs 226 and 230, and Classes 224 and 228 into a different machine language which is directly executable on the underlying hardware.

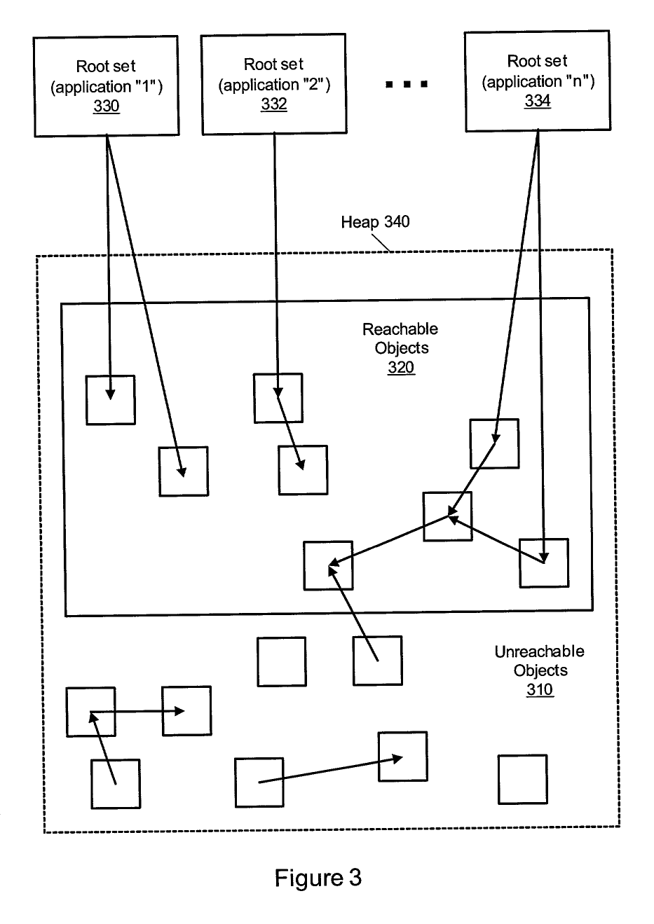

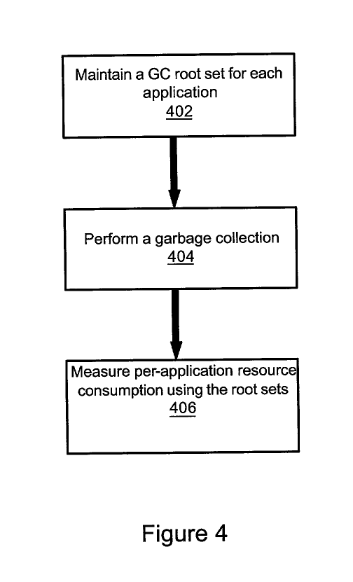

FIGS. 3 and 4: Secure Execution of Multiple Applications Using a Single GC Heap

FIGS. 3 and 4 illustrate one approach towards secure execution of multiple applications according to one embodiment. In one embodiment, a GC root set may be maintained in memory for each application. GC heap consumption for an application may be measured based on the reachability of objects in the GC heap from that application's root set. The number of alive objects per application may then be counted after GC based on the number of reachable objects from each application's root set. This approach may solve the first problem identified in the Description of the Relevant Art by permitting the measurement of GC heap consumption per application. In other embodiments, the methods described herein may be performed upon data structures rather than objects, such as in a programming environment that is not object-oriented.

An executing program (such as a Java™ program) may include a set of threads. Threads provide a way to achieve multi-tasking in a single processing space. If an application desires to run animations and play music while scrolling the page and downloading a text file from a server, for example, then multithreading provides fast, lightweight concurrency within a single process space. Threads are sometimes referred to as lightweight processes or execution contexts. Each of the threads may be actively executing a set of methods (one method having called the next). Each of these methods may have arguments or local variables that are references to objects. These references are said to belong to a “root set” of references that are immediately accessible to the program. Other references in the root set may include, for example, static reference variables defined in loaded classes and references registered through the Java™ Native Interface (JNI) API.

FIG. 3 shows a heap 340 and a series of per-application root sets 330, 332, and 334. In one embodiment, all objects referenced by a root set of references are said to be reachable and are not to be collected during a GC. Also, those objects may include references to still other objects, which are also reachable, and so on. Collectively, these objects (both directly and indirectly reachable by a root set) are shown in FIG. 3 as reachable objects 320 for the root sets 330, 332, and 334. All other objects on the heap may be considered unreachable, and all unreachable objects 310 may be eligible for garbage collection. If an unreachable object has a finalizer method, arrangements may be made for the object's finalizer to be called. Unreachable objects with no finalizers and objects whose finalizers have been called may simply be reclaimed during garbage collection.

FIG. 4 is a flowchart illustrating a method of secure execution of multiple applications using a single GC heap according to one embodiment. In 402, a GC root set may be maintained in a memory for each application as discussed with reference to FIG. 3. Each root set may include one or more pointers to data structures (e.g., objects) that have been created in memory (usually in a part of the memory called a “heap” or “GC heap”) for the applications. In one embodiment, an application may include multiple threads. To assist in keeping track of a GC root set per application, an application identifier (application ID) may be associated with each thread belonging to the application. In one embodiment, this may be performed by adding a field to each thread and storing the proper application ID in the field. In another embodiment, a ThreadGroup feature of the Java™ Language may be used to keep track of all the threads of an application.

In 404, a garbage collection operation may be performed on the memory. The garbage collection operation may include determining which of the data structures is in use and then reclaiming data structures that are not in use.

In 406, the root sets may be used to measure the resource consumption for each of the plurality of applications. For example, the amount of memory (i.e., in the GC heap) consumed by each application may be determined by linking data structures in the memory to a particular application based on the reachability of those data structures from the application's root set. In one embodiment, CPU time for a garbage collection operation (GC) may be charged to applications by dividing up the entire time taken based on the GC by freed heap size or number of freed objects for each application.

In some cases, certain data structures (such as objects) may not be reachable from the ordinary GC root sets even though they are in use. To prevent their unwanted reclamation during GC, these data structures may be registered with an appropriate application ID prior to GC. During GC, these data structures may be linked to the appropriate application as described in 406.

The following pseudo-code is provided as an example of one embodiment of the approach illustrated by FIGS. 3 and 4.

| | |
|---|---|
| S[ ] | := global counters to accumulate sizes of all the objects used |
| | on a per-application basis |
| N[ ] | := global counters to count the number of objects reachable on |
| | a per-application basis |
| FQ[ ] | := global finalization queue in which to keep finalizable |
| | objects on a per-application basis |

mark - pointers

a[ ] := all the applications
for each application b in a[ ]

| set 0 to S[b] | |
|---|---|
| set 0 to N[b] | |
| t[ ]:= | all the threads belonging to the target |

application b

for each thread u in t[ ]

p[ ] := all the object pointers in the stack

frames of u

for each pointer q in [p]

if q is not marked yet

do mark-recursively (q, b)

fi

rof

rof
r[ ] := all the registered objects associated with

application b

for each object s in r[ ]

if s is not marked yet

do mark-recursively (s, b)

fi

rof
for each object o in FQ[b]

if o is not marked yet

do mark-recursively (o, b)

fi

rof

rof

mark-recursively (object q, application b)

mark q
increment S[b] by the size of q
increment N[b] by 1
r[ ] := Object pointers in the object q

If q is a class object and has replicated static
fields per-application, include replicated static
fields for the target application (b) only
for each pointer v in r[ ]

if v is not marked yet
do mark-recursively (v, b)

fi

rof

In one embodiment, CPU time for a GC may be charged to applications by dividing up the entire time taken based on the GC by freed heap size or number of freed objects for each application. As described with reference to FIGS. 3 and 4, a GC root set may be maintained for each application. Objects may be linked to an application based on reachability from each application's root set. This approach may solve the second problem identified in the Description of the Relevant Art by making each application responsible for a reasonable proportion of time consumed by the GC. The following pseudo-code is provided as an example of one embodiment of this approach.

C[ ]:=global counters to accumulate time consumption on a per-application basis

start-GC

s := start time of GC
Sbefore[ ] := copy of all of S[ ]
Nbefore[ ] := copy of all of N[ ]
do GC (may perform the above-discussed procedure for mark-

pointers)

e := end time of GC
d := e − s (elapsed time in CPU time)
Sdiff[ ] := Sbefore[ ] − S[ ]
Ndiff [ ] := Nbefore[ ] − N[ ]
if sum of Sdiff is not 0

a[ ] := all the applications
for each application b in a[ ]

C[b] := (d * Sdiff[b] / (sum of Sdiff[ ])

rof

fi

In another embodiment, the line “if sum of Sdiff is not 0” may be replaced by “if sum of Ndiff is not 0”, and the line “C[b]:=(d*Sdiff[b])/(sum of Sdiff [ ])” may be replaced by “C[b]:=(d*Ndiff[b])/(sum of Ndiff[ ])”.

In one embodiment, finalizer threads may be assigned to each application. Object finalizers may be executed for the finalizer thread for the appropriate application. This approach may solve the third problem identified in the Description of the Relevant Art by limiting GC-related misbehavior to GC of the objects of the misbehaving application itself. The following pseudo-code is provided as an example of one embodiment of this approach. In one embodiment, new-object may be executed when the system creates a new object. Find-executable-finalizer may be executed during the GC. Each application may start a new thread which executes finalizer-loop.

new-object(class c, size s)

t := current thread ID
a := application ID of thread t
o := allocate memory area of size s for a new object o of

class c

increment S[a] by s
increment N[a] by 1
if c has finalizer

put (o and a) in the has-finalizer queue

fi

FQ[ ] := global finalization queue in which to keep finalizable

objects on a per-application basis

find-application-finalizer

f[ ] := all the objects in the has-finalizer queue
for each object o in f[ ]

if o is not marked

remove (o and a) from the has-finalizer queue

and put o in FQ[a]

fi

rof

finalizer-loop

while JVM is running

a := application ID of this finalizer thread
get an object o from finalization queue FQ[a]
execute finalizer of o

elihw

In one embodiment, static fields of some classes may be shared among applications. To prevent the compromising of the GC security measures summarized above, static fields that would otherwise be shared between applications may be maintained on a per-application basis. The plurality of applications may utilize one or more “original” classes. In other words, the original classes may be shared by a plurality of applications. In one embodiment, new classes may be created to replace the original classes in order to isolate the execution of the applications, such that different applications cannot typically access the same static fields. In one embodiment, only one copy of each original class is maintained, regardless of how many applications utilize it. Classes may be transparently and automatically modified, so that each application has a separate copy of its static fields. In one embodiment, one or more static fields are extracted from one or more original classes utilized by any of the plurality of applications, wherein each of the one or more original classes includes at least one static field. In one embodiment, a separate copy of the one or more static fields is created for each of the plurality of applications, wherein each of the separate copies corresponds to one of the plurality of applications. Creating the separate copy of the one or more static fields may include creating a static field class which includes instance fields corresponding to the one or more static fields, wherein each instance of the static field class corresponds to one of the plurality of applications. In one embodiment, one or more access methods for the one or more static fields may be created. The access methods are operable to access the corresponding separate copy of the one or more static fields based upon the identity of the utilizing or calling application. Creating access methods for the one or more static fields may include creating a single access methods class for each original class which includes the access methods for accessing the extracted fields from the original class. In one embodiment, the method for isolating the execution of the applications is transparent to the utilizing applications. In various embodiments, the extraction of the static fields, creation of the separate copies of the static fields, and creation of the access methods may be performed at run-time or at compilation, and at the source level or the bytecode level.

Various embodiments may further include receiving or storing instructions and/or data implemented in accordance with the foregoing description upon a carrier medium. Suitable carrier media may include storage media or memory media such as magnetic or optical media, e.g., disk or CD-ROM, as well as transmission media or signals such as electrical, electromagnetic, or digital signals, conveyed via a communication medium such as network 108 and/or a wireless link.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. A method for sharing a memory among a plurality of applications, the method comprising:
maintaining a root set for each of the plurality of applications during execution of the plurality of applications on a computer system, wherein each root set comprises one or more pointers to data structures stored in the memory;
performing a garbage collection operation on the memory, wherein the garbage collection operation comprises:
determining which of the data structures is in use; and
reclaiming data structures that are not in use; and
using the root sets to measure one or more resources consumed by each of the plurality of applications.

2. The method of claim 1,
wherein the measured resource comprises memory consumption;
wherein the using the root sets to measure one or more resources consumed by each of the plurality of applications comprises:
associating each data structure in the memory with a particular one of the plurality of applications based on reachability from the root set of the particular one of the plurality of applications; and
determining a total amount of the memory used by the particular one of the plurality of applications by summing the memory consumption of each of the data structures associated with the particular one of the plurality of applications.

3. The method of claim 1,
wherein the measured resource comprises CPU time consumption during the garbage collection operation.

4. The method of claim 3,
wherein the using the root sets to measure one or more resources consumed by each of the plurality of applications comprises:
determining a total CPU time consumed by the garbage collection operation;
determining a total amount of the memory used by each of the plurality of applications; and
determining CPU time consumption for each of the plurality of applications by dividing the total time consumed by the garbage collection operation by the total amount of the memory used by each of the plurality of applications.

5. The method of claim 3,
wherein the using the root sets to measure one or more resources consumed by each of the plurality of applications comprises:
determining a total CPU time consumed by the garbage collection operation;
determining a total number of data structures in the memory for each of the plurality of applications; and
determining CPU time consumption for each of the plurality of applications by dividing the total time consumed by the garbage collection operation by the total number of data structures in the memory for each of the plurality of applications.

6. The method of claim 1,
wherein at least one of the plurality of applications comprises a plurality of threads; and
wherein the method further comprises:
storing an application identifier with each of the plurality of threads belonging to the at least one of the plurality of applications, wherein the application identifier refers to the at least one of the plurality of applications.

7. The method of claim 1,
wherein each of the plurality of applications comprises a finalizer thread; and
wherein the method further comprises:
executing an object finalizer in the finalizer thread for each of the plurality of applications.

8. The method of claim 1, further comprising:
extracting one or more static fields from an original class utilized by any of the plurality of applications, wherein the original class comprises at least one static field;
creating a separate copy of the one or more static fields for each of the plurality of applications, wherein each of the separate copies corresponds to one of the plurality of applications; and
creating one or more access methods for the one or more static fields, wherein the access methods are operable to access the corresponding separate copy of the one or more static fields based upon the identity of the utilizing application.

9. A carrier medium comprising program instructions for sharing a memory among a plurality of applications, wherein the program instructions are computer-executable to implement:
maintaining a root set for each of the plurality of applications during execution of the plurality of applications on the computer, wherein each root set comprises one or more pointers to data structures stored in the memory;
performing a garbage collection operation on the memory, wherein the garbage collection operation comprises:
determining which of the data structures is in use; and
reclaiming data structures that are not in use; and
using the root sets to measure one or more resources consumed by each of the plurality of applications.

10. The carrier medium of claim 9,
wherein the measured resource comprises memory consumption;
wherein in the using the root sets to measure one or more resources consumed by each of the plurality of applications, the program instructions are further computer-executable to implement:
associating each data structure in the memory with a particular one of the plurality of applications based on reachability from the root set of the particular one of the plurality of applications; and
determining a total amount of the memory used by the particular one of the plurality of applications by summing the memory consumption of each of the data structures associated with the particular one of the plurality of applications.

11. The carrier medium of claim 9,
wherein the measured resource comprises CPU time consumption during the garbage collection operation.

12. The carrier medium of claim 11,
wherein in the using the root sets to measure one or more resources consumed by each of the plurality of applications, the program instructions are further computer-executable to implement:
determining a total CPU time consumed by the garbage collection operation;
determining a total amount of the memory used by each of the plurality of applications; and
determining CPU time consumption for each of the plurality of applications by dividing the total time consumed by the garbage collection operation by the total amount of the memory used by each of the plurality of applications.

13. The carrier medium of claim 11,
wherein in the using the root sets to measure one or more resources consumed by each of the plurality of applications, the program instructions are further computer-executable to implement:
determining a total CPU time consumed by the garbage collection operation;
determining a total number of data structures in the memory for each of the plurality of applications; and
determining CPU time consumption for each of the plurality of applications by dividing the total time consumed by the garbage collection operation by the total number of data structures in the memory for each of the plurality of applications.

14. The carrier medium of claim 9,
wherein at least one of the plurality of applications comprises a plurality of threads; and
wherein the program instructions are further computer-executable to implement:
storing an application identifier with each of the plurality of threads belonging to the at least one of the plurality of applications, wherein the application identifier refers to the at least one of the plurality of applications.

15. The carrier medium of claim 9,
wherein each of the plurality of applications comprises a finalizer thread; and
wherein the program instructions are further computer-executable to implement:
executing an object finalizer in the finalizer thread for each of the plurality of applications.

16. The carrier medium of claim 9, wherein the program instructions are further computer-executable to implement:
extracting one or more static fields from an original class utilized by any of the plurality of applications, wherein the original class comprises at least one static field;
creating a separate copy of the one or more static fields for each of the plurality of applications, wherein each of the separate copies corresponds to one of the plurality of applications; and
creating one or more access methods for the one or more static fields, wherein the access methods are operable to access the corresponding separate copy of the one or more static fields based upon the identity of the utilizing application.

17. A system for sharing a memory among a plurality of applications, wherein the system comprises:
a CPU;
a memory coupled to the CPU, wherein the memory stores a plurality of applications which are executable by the CPU, and wherein the memory stores program instructions which are executable by the CPU to:
maintain a root set for each of the plurality of applications during execution of the plurality of applications, wherein each root set comprises one or more pointers to data structures stored in the memory;
perform a garbage collection operation on the memory, wherein in the garbage collection operation, the program instructions are executable by the CPU to:
determine which of the data structures is in use; and
reclaim data structures that are not in use; and
use the root sets to measure one or more resources consumed by each of the plurality of applications.

18. The system of claim 17,
wherein the measured resource comprises memory consumption;
wherein in the using the root sets to measure one or more resources consumed by each of the plurality of applications, the program instructions are executable by the CPU to:
associate each data structure in the memory with a particular one of the plurality of applications based on reachability from the root set of the particular one of the plurality of applications; and
determine a total amount of the memory used by the particular one of the plurality of applications by summing the memory consumption of each of the data structures associated with the particular one of the plurality of applications.

19. The system of claim 17,
wherein the measured resource comprises CPU time consumption during the garbage collection operation.

20. The system of claim 19,
wherein in the using the root sets to measure one or more resources consumed by each of the plurality of applications, the program instructions are executable by the CPU to:
determine a total CPU time consumed by the garbage collection operation;
determine a total amount of the memory used by each of the plurality of applications; and
determine CPU time consumption for each of the plurality of applications by dividing the total time consumed by the garbage collection operation by the total amount of the memory used by each of the plurality of applications.

21. The system of claim 19,
wherein in the using the root sets to measure one or more resources consumed by each of the plurality of applications, the program instructions are executable by the CPU to:
determine a total CPU time consumed by the garbage collection operation;
determine a total number of data structures in the memory for each of the plurality of applications; and
determine CPU time consumption for each of the plurality of applications by dividing the total time consumed by the garbage collection operation by the total number of data structures in the memory for each of the plurality of applications.

22. The system of claim 17,
wherein at least one of the plurality of applications comprises a plurality of threads; and
wherein the program instructions are executable by the CPU to:
store an application identifier with each of the plurality of threads belonging to the at least one of the plurality of applications, wherein the application identifier refers to the at least one of the plurality of applications.

23. The system of claim 17,
wherein each of the plurality of applications comprises a finalizer thread; and
wherein the program instructions are executable by the CPU to:
execute an object finalizer in the finalizer thread for each of the plurality of applications.

24. The system of claim 17, wherein the program instructions are executable by the CPU to:
extract one or more static fields from an original class utilized by any of the plurality of applications, wherein the original class comprises at least one static field;
create a separate copy of the one or more static fields for each of the plurality of applications, wherein each of the separate copies corresponds to one of the plurality of applications; and
create one or more access methods for the one or more static fields, wherein the access methods are operable to access the corresponding separate copy of the one or more static fields based upon the identity of the utilizing application.
